(19) United States
(12) Patent Application Publication
(10) Pub. No.: US 2015/0063057 A1
(43) Pub. Date: Mar. 5, 2015

(54) ULTRASONIC MEASUREMENT APPARATUS, ULTRASONIC IMAGING APPARATUS, AND ULTRASONIC MEASUREMENT METHOD

(71) Applicant: SEIKO EPSON CORPORATION, Tokyo (JP)

(72) Inventors: Masaki HAYASHI, Matsumoto (JP); Kazuyuki KANO, Ichinomiya (JP)

(21) Appl. No.: 14/470,451

(22) Filed: Aug. 27, 2014

(30) Foreign Application Priority Data
Sep. 5, 2013 (JP) 2013-183799

(51) Int. Cl. G01S 7/52; G01S 15/02

(52) U.S. Cl. CPC G01S 7/52023; G01S 15/02
USPC 367/7

(57) ABSTRACT

An ultrasonic wave of a predetermined wavelength is transmitted toward an object from channels that are constituted by ultrasonic transducer elements, and reception waves of ultrasonic echoes relating to the transmitted ultrasonic wave are acquired from the channels. When information showing a normal mode or a low power consumption mode shows the normal mode, a first number of reception signals are added together with a weight that is computed in advance, and image generation is performed based on the reception signal obtained from the adding, and when the information shows the low power consumption mode, a second number of reception signals that is less than the first number is added together with a weight that depends on each reception signal, and image generation is performed based on the reception signal obtained from the adding.

### BACKGROUND

1. Technical Field

The present invention relates to an ultrasonic measurement apparatus, an ultrasonic imaging apparatus, and an ultrasonic measurement method.

2. Related Art

JP-A-2003-175035 discloses an ultrasonic diagnostic apparatus that determines units whose operation can be stopped or restricted according to an operating condition of the apparatus that is notified from a control unit, selects a power save method from a plurality of power save methods including power off, clock off, reducing clock frequency, switching to sleep mode, and the like, based on characteristics of the units that are determined to be able to stop or restrict operation, and executes operation restriction control for implementing power saving with the selected power save method.

JP-WO-A-2010/53008 discloses an ultrasonic diagnostic apparatus that is provided with an ultrasonic probe for transmitting and receiving ultrasonic waves, a transmission unit for providing a signal to the ultrasonic probe and causing the ultrasonic probe to form an ultrasonic beam, a reception unit for receiving a reception signal that is obtained by transmitting the ultrasonic beam toward a subject, a signal processing unit for forming an ultrasonic image based on the reception signal, a display unit that displays the ultrasonic image, and a control unit for controlling the transmission unit, the reception unit, the signal processing unit and the display unit, and that sets an operating mode of the transmission unit to a low power consumption operating mode or a high spatial resolution operating mode.

With the invention disclosed in JP-A-2003-175035, low power consumption of the ultrasonic diagnostic apparatus is achieved by turning off the power supply and the clock in units of circuit modules such as the transmission unit and the reception unit. For example, power supply to the transmission module which does not need to operate at the time of reception is stopped during the reception period. Accordingly, there is a problem with the invention disclosed in JP-A-2003-175035 in that power consumption at the time of image generation cannot be reduced.

With the invention disclosed in JP-WO-A-2010/53008, there is a problem in that spatial resolution deteriorates in the low power consumption mode, since power consumption is reduced in the low power consumption mode at the cost of the linear operation of the linear transmission amplification circuit.

### SUMMARY

An advantage of some aspects of the invention is to provide an ultrasonic measurement apparatus, an ultrasonic imaging apparatus, and an ultrasonic measurement method that are able to achieve low power consumption together with high resolution.

An ultrasonic measurement apparatus according to a first aspect of the invention is provided with an ultrasonic transducer device that includes channels constituted by ultrasonic transducer elements that transmit and receive an ultrasonic wave; a reception processing unit that performs, when information showing a normal mode or a low power consumption mode shows the normal mode, processing for receiving a first number of ultrasonic echoes from among ultrasonic echoes relating to the transmitted ultrasonic wave that are acquired from the channels, that performs, when the information shows the low power consumption mode, processing for receiving a second number of ultrasonic echoes that is less than the first number from among ultrasonic echoes relating to the transmitted ultrasonic wave that are acquired from the channels, and that outputs reception signals obtained from the reception processing; and an image processing unit that receives input of the reception signals output from the reception processing unit, that adds together the first number of the reception signals with a weight that is computed in advance and performs image generation based on the reception signal obtained from the adding, when the information shows the normal mode, and that adds together the second number of the reception signals with a weight that depends on the reception signals and performs image generation based on the reception signal obtained from the adding, when the information shows the low power consumption mode.

According to this aspect, an ultrasonic wave is transmitted from channels that are constituted by ultrasonic transducer elements. Processing for receiving a first number of ultrasonic echoes, from among ultrasonic echoes relating to the transmitted ultrasonic wave that are acquired from the channels, is performed when information showing a normal mode or a low power consumption mode shows the normal mode, processing for receiving a second number of ultrasonic echoes that is less than the first number, from among the ultrasonic echoes relating to the transmitted ultrasonic wave that are acquired from the channels, is performed when the information shows the low power consumption mode, and reception signals obtained from the reception processing are output. When the information shows the normal mode, the first number of reception signals are added together with a weight that is computed in advance and image generation is performed based on the reception signal obtained from the adding, and when the information shows the low power consumption mode, the second number of reception signals are added together with a weight that depends on each reception signal, and image generation is performed based on the reception signal obtained from the adding. In the case of the low power consumption mode, the number of channels can thereby be reduced and low power consumption can be achieved. Also, in the case of the low power consumption mode, high resolution can be achieved by adding together the reception signals with a weight that depends on the reception signals. That is, low power consumption can be achieved together with high resolution.

An ultrasonic measurement apparatus according to a second aspect of the invention is provided with an ultrasonic transducer device; a transmission processing unit that transmits an ultrasonic wave of a predetermined wavelength toward an object from a first number of channels of the ultrasonic transducer device; a channel selection unit that acquires information showing a normal mode or a low power consumption mode, and selects channels to be used so as to acquire, from the first number of channels, reception waves of ultrasonic echoes relating to the transmitted ultrasonic wave, when information showing the normal mode is acquired, and to acquire, from a second number of channels that is less than the first number, reception waves of ultrasonic echoes relating to the transmitted ultrasonic wave, when information showing the low power consumption mode is acquired; a reception processing unit that performs processing for receiving the reception waves of the ultrasonic echoes relating to the transmitted ultrasonic wave that are acquired from the first number of channels or the second number of channels, and outputs a reception signal of each channel obtained from the reception processing; and an image processing unit that adds together the reception signals of the channels output from the reception processing unit with a weight that is computed in advance, when information showing the normal mode is acquired, adds together the reception signals of the channels output from the reception processing unit with a weight that depends on the reception signals, when information showing the low power consumption mode is acquired, and performs image generation based on the reception signal obtained from the adding.

According to this aspect, an ultrasonic wave of a predetermined wavelength is transmitted from a first number of channels of the ultrasonic transducer device toward an object, reception waves of ultrasonic echoes relating to the transmitted ultrasonic wave are acquired from the first number of channels, when information showing the normal mode is acquired, and reception waves of ultrasonic echoes relating to the transmitted ultrasonic wave are acquired from a second number of channels that is less than the first number, when information showing the low power consumption mode is acquired. Processing for receiving the reception waves of the ultrasonic echoes relating to the transmitted ultrasonic wave that are acquired from the first number of channels or the second number of channels is performed, and a reception signal of each channel obtained from the reception processing is output. The reception signals are added together with a weight that is computed in advance, when information showing the normal mode is acquired, the reception signals are added together with a weight that depends on the reception signals, when information showing the low power consumption mode is acquired, and image generation is performed based on the reception signal obtained from the adding. When information showing the low power consumption mode is acquired, the number of channels can thereby be reduced and low power consumption can be achieved. Also, when information showing the low power consumption mode is acquired, high resolution can be achieved by adding together the reception signals with a weight that depends on the reception signals. That is, low power consumption can be achieved together with high resolution.

Here, the channel selection unit may, when information showing the low power consumption mode is acquired, select the second number of channels that are located in a central portion of the first number of channels. The occurrence of grating lobes can thereby be suppressed, particularly in the case where the frequency is high.

Here, the channel selection unit may, when information showing the low power consumption mode is acquired, select the second number of channels such that an interval between adjacent channels in the second number of channels is the largest interval that satisfies the condition of being less than half the wavelength of the transmitted ultrasonic wave. The occurrence of grating lobes can thereby be suppressed, particularly in the case where the frequency is low.

Here, the channel selection unit may acquire information showing the relationship between the frequency of the transmitted ultrasonic wave and the second number of channels, and select the second number of channels based on the acquired information. The second number of channels can thereby be appropriately selected according to the frequency.

Here, the channel selection unit may, when information showing the low power consumption mode is acquired, select the second number of channels by adding together a plurality of channels among the first number of channels to serve as one channel. The number of channels can thereby be reduced while maintaining the sound pressure of the signals.

Here, the image processing unit may derive the weight that depends on the reception signal of each channel of the second number of channels, so as to minimize the variance of the result of multiplying the output signal of each channel of the second number of channels after a delay time that depends on the linear distance from the object to the channel by the weight that depends on the reception signal of the channel. The weight of each channel can thereby be changed according to the incoming wave.

Here, the image processing unit may, when information showing the low power consumption mode is acquired, derive the weight of each channel after extracting a plurality of sub apertures from an aperture constituted by the second number of channels and taking respective averages thereof. Deterioration of the azimuth estimation accuracy due to the influence of interference waves having correlativity can thereby be prevented.

An ultrasonic imaging apparatus according to a third aspect of the invention is provided with an ultrasonic transducer device; a transmission processing unit that transmits an ultrasonic wave of a predetermined wavelength toward an object from a first number of channels of the ultrasonic transducer device; a channel selection unit that acquires information showing a normal mode or a low power consumption mode, and selects channels to be used so as to acquire, from the first number of channels, ultrasonic echoes relating to the transmitted ultrasonic wave, when information showing the normal mode is acquired, and to acquire, from a second number of channels that is less than the first number, ultrasonic echoes relating to the transmitted ultrasonic wave, when information showing the low power consumption mode is acquired; a reception processing unit that performs processing for receiving the ultrasonic echoes relating to the transmitted ultrasonic wave that are acquired from the first number of channels or the second number of channels, and outputs a reception signal of each channel obtained from the reception processing; an image processing unit that adds together the reception signals of the channels output from the reception processing unit with a weight that is computed in advance, when information showing the normal mode is acquired, adds together the reception signals of the channels output from the reception processing unit with a weight that depends on each reception signal, when information showing the low power consumption mode is acquired, and performs image generation based on the reception signal obtained from the adding; and a display unit that displays the generated image. Low power consumption can thereby be achieved together with high resolution.

An ultrasonic measurement method according to a fourth aspect of the invention includes transmitting an ultrasonic wave of a predetermined wavelength toward an object from a first number of channels of an ultrasonic transducer device; acquiring information showing a normal mode or a low power consumption mode, and selecting channels to be used so as to acquire, from the first number of channels, ultrasonic echoes relating to the transmitted ultrasonic wave, when information showing the normal mode is acquired, and to acquire, from a second number of channels that is less than the first number, ultrasonic echoes relating to the transmitted ultrasonic wave, when information showing the low power consumption mode is acquired; performing processing for receiving the ultrasonic echoes relating to the transmitted ultrasonic wave that are acquired from the first number of channels or the second number of channels, and outputting a reception signal of each channel obtained from the reception processing; and adding together the output reception signals of the channels with a weight that is computed in advance, when the information showing the normal mode is acquired, adding together the output reception signals of the channels with a weight that depends on each reception signal, when information showing the low power consumption mode is acquired, and performing image generation based on the reception signal obtained from the adding. Low power consumption can thereby be achieved together with high resolution.

### BRIEF DESCRIPTION OF THE DRAWINGS

The invention will be described with reference to the accompanying drawings, wherein like numbers reference like elements.

FIG. 1 is a perspective diagram showing a schematic configuration of an ultrasonic measurement apparatus 1 according to a first embodiment of the invention.

FIGS. 2A to 2C show an exemplary schematic configuration of an ultrasonic transducer element.

FIG. 3 shows an exemplary configuration of an ultrasonic transducer device (element chip).

FIGS. 4A and 4B show exemplary ultrasonic transducer element groups UG (UG1 to UG64), with FIG. 4A showing the case where there are four element columns, and FIG. 4B showing the case where there is one element column.

FIG. 5 is a block diagram showing an exemplary functional configuration of a control unit.

FIG. 6 illustrates a signal delay at each channel.

FIG. 7 illustrates sub apertures in spatial averaging.

FIG. 8 shows an exemplary schematic configuration of a control unit 22.

FIG. 9 is a flowchart showing the flow of the overall processing by the ultrasonic measurement apparatus 1.

FIG. 10 is a flowchart showing the flow of processing in a normal mode of the ultrasonic measurement apparatus 1.

FIG. 11 is a flowchart showing the flow of processing in a low power consumption mode of the ultrasonic measurement apparatus 1.

FIGS. 12A and 12B illustrate use configurations of the channels, with FIG. 12A showing the case of the normal mode, and FIG. 12B showing the case of the low power consumption mode.

FIGS. 13A and 13B illustrate use configurations of the channels, with FIG. 13A showing the case of the normal mode, and FIG. 13B showing the case of the low power consumption mode.

FIG. 14 is an exemplary channel selection table showing the relationship between frequency and channels to be used.

FIG. 15 is a block diagram showing an exemplary functional configuration of a control unit in an ultrasonic measurement apparatus 2 according to a second embodiment of the invention.

FIG. 16 is a flowchart showing the flow of processing in a low power consumption mode of the ultrasonic measurement apparatus 2.

FIGS. 17A and 17B illustrate use configurations of the channels, with FIG. 17A showing the case of the normal mode, and FIG. 17B showing the case of the low power consumption mode.

### DESCRIPTION OF EXEMPLARY EMBODIMENTS

Embodiments of the invention will now be described with reference to the drawings.

### Configuration of First Embodiment

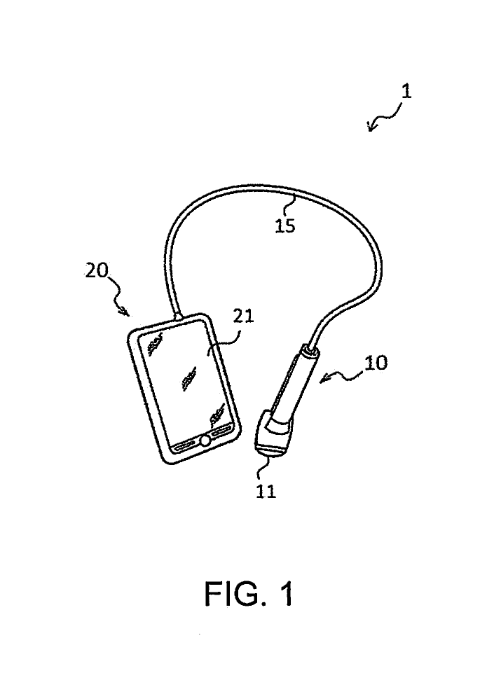

FIG. 1 shows a general view of an ultrasonic measurement apparatus 1 according to a first embodiment of the invention. The ultrasonic measurement apparatus 1 is, for example, a compact ultrasonic measurement apparatus. The ultrasonic measurement apparatus 1 primarily includes an ultrasonic probe 10 and an ultrasonic measurement apparatus main body 20, with the ultrasonic probe 10 and the ultrasonic measurement apparatus main body 20 being connected by a cable 15. Note that the ultrasonic measurement apparatus 1 is not limited to being a compact ultrasonic measurement apparatus, and may be, for example, a stationary ultrasonic measurement apparatus, or an integrated ultrasonic measurement apparatus in which the ultrasonic probe is built into the main body.

Also, the ultrasonic measurement apparatus 1 uses an ultrasonic element array that enables linear scanning and sector scanning, and employs electronic focusing. In the case of linear scanning, the aperture is divided, transmission and reception are performed with the resultant apertures, and lines are generated. Also, in the case of sector scanning, lines are generated, while changing the transmission timing (delay time) of respective channels of the full aperture, and changing the beam direction. Hereinafter, the case where the ultrasonic measurement apparatus 1 performs linear scanning will be described as an example.

The ultrasonic probe 10 has an ultrasonic transducer device 11. The ultrasonic transducer device 11 transmits an ultrasonic beam toward an object while scanning over the object along a scan surface, and receives ultrasonic echoes resulting from the ultrasonic beam.

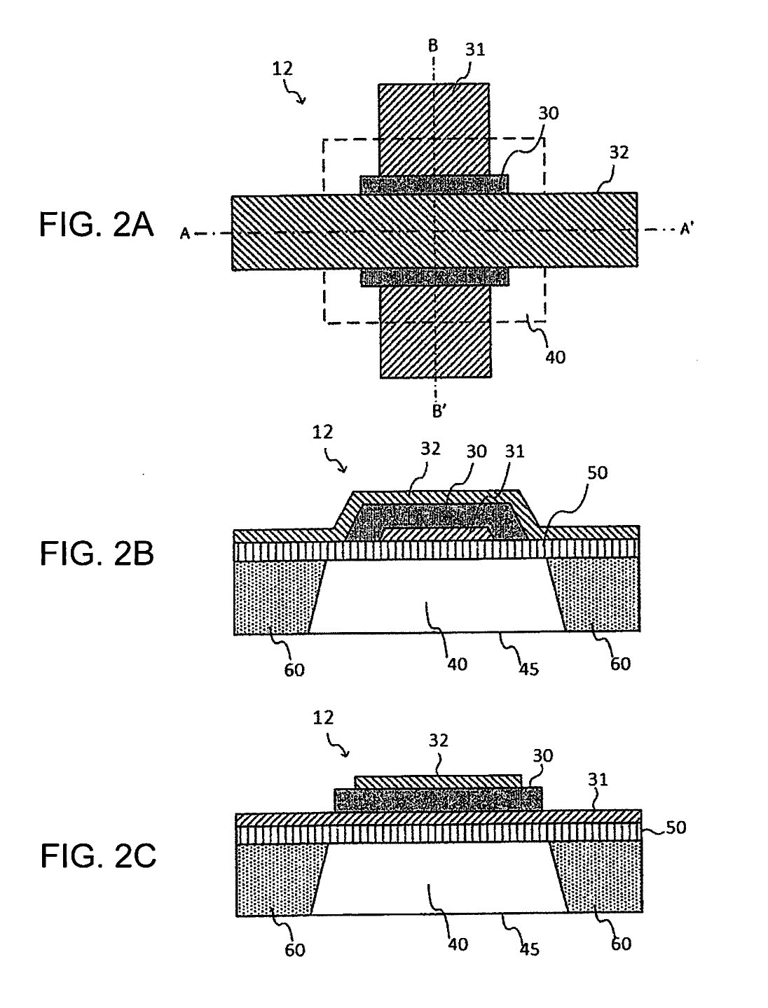

Taking a type that uses piezoelectric elements as an example, the ultrasonic transducer device 11 has a plurality of ultrasonic transducer elements 12 (ultrasonic element array; refer to FIGS. 2A to 2C, etc.) and a substrate in which a plurality of apertures are disposed in an array.

FIGS. 2A to 2C show an exemplary configuration of the ultrasonic transducer elements 12 of the ultrasonic transducer device 11. In the present embodiment, a monomorph (unimorph) structure in which thin piezoelectric elements and a metal plate (vibration film) are stuck together is employed as the ultrasonic transducer elements 12.

FIGS. 2A to 2C show an exemplary configuration of an ultrasonic transducer element 12 of the ultrasonic transducer device 11. FIG. 2A is a plan view of an ultrasonic transducer element 12 formed on a substrate (silicon substrate) 60 viewed from an element formation side in a direction perpendicular to a substrate 60. FIG. 2B is a cross-sectional view showing a cross-section along A-A′ in FIG. 2A. FIG. 2C is a cross-sectional view showing a cross-section along B-B′ in FIG. 2A.

The ultrasonic transducer element 12 has a piezoelectric element part and a vibration film (membrane, supporting member) 50. The piezoelectric element part primarily includes a piezoelectric layer (piezoelectric film) 30, a first electrode layer (lower electrode) 31, and a second electrode layer (upper electrode) 32.

The piezoelectric layer 30 is formed using a PZT (lead zirconate titanate) thin film, for example, and is provided so as to cover at least a portion of the first electrode layer 31. Note that the material of the piezoelectric layer 30 is not limited to PZT, and materials such as lead titanate (PbTiO₃), lead zirconate (PbZrO₃) and lead lanthanum titanate ((Pb, La)TiO₃), for example, may be used.

The first electrode layer 31 is formed on an upper layer of the vibration film 50 with a metal thin film, for example. This first electrode layer 31 may be an interconnect that extends to outside the element formation area as shown in FIG. 2A, and is connected to an adjacent ultrasonic transducer element 12.

The second electrode layer 32 is formed with a metal thin film, for example, and is provided so as to cover at least a portion of the piezoelectric layer 30. This second electrode layer 32 may be an interconnect that extends to outside the element formation area as shown in FIG. 2A, and is connected to an adjacent ultrasonic transducer element 12.

The lower electrode of the ultrasonic transducer element 12 is formed by the first electrode layer 31, and the upper electrode is formed by the second electrode layer 32. Specifically, the portion of the first electrode layer 31 covered by the piezoelectric layer 30 forms the lower electrode, and the portion of the second electrode layer 32 covering the piezoelectric layer 30 forms the upper electrode. That is, the piezoelectric layer 30 is provided so as to be sandwiched between the lower electrode and the upper electrode.

An aperture 40 is formed by etching such as reactive ion etching (RIE) or the like from the back surface (surface on which the element is not formed) side of the substrate 60. The resonance frequency of ultrasonic waves is determined by the size of the aperture 40, with the ultrasonic waves being emitted to the piezoelectric layer 30 side (in a direction from far to near in FIG. 2A).

The vibration film 50 is provided so as to close the aperture 40 using a two layer structure consisting of a SiO₂ thin film and a ZrO₂ thin film, for example. This vibration film 50 supports the piezoelectric layer 30 and the first and second electrode layers 31 and 32, and produces ultrasonic waves by vibrating in accordance with the expansion and contraction of the piezoelectric layer 30.

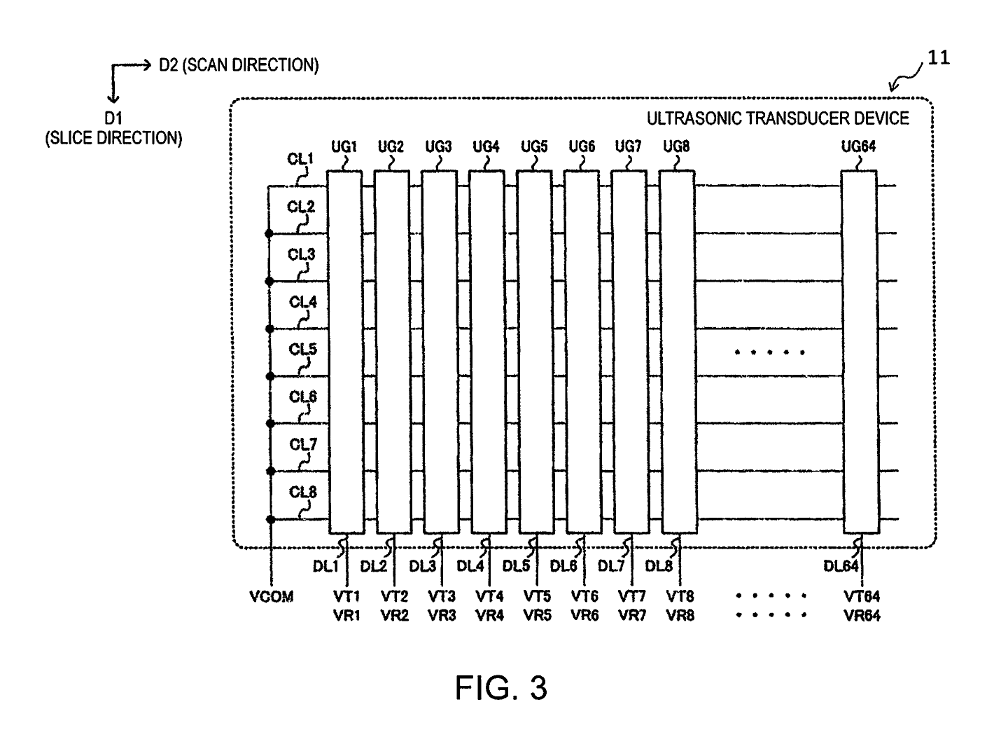

FIG. 3 shows an exemplary configuration of the ultrasonic transducer device (element chip). The ultrasonic transducer device of this exemplary configuration includes a plurality of ultrasonic transducer element groups UG1 to UG64 and drive electrode lines DL1 to DL64 (broadly, 1st to mth drive electrode lines, where m is an integer of 2 or more) and common electrode lines CL1 to CL8 (broadly, 1st to nth common electrode lines, where n is an integer of 2 or more). Note that the number (m) of drive electrode lines and the number (n) of common electrode lines are not limited to the numbers shown in FIG. 3.

The plurality of ultrasonic transducer element groups UG1 to UG64 are disposed in 64 columns in a second direction D2 (scan direction). Each of the ultrasonic transducer element groups UG1 to UG64 has a plurality of ultrasonic transducer elements that are disposed in a first direction D1 (slice direction).

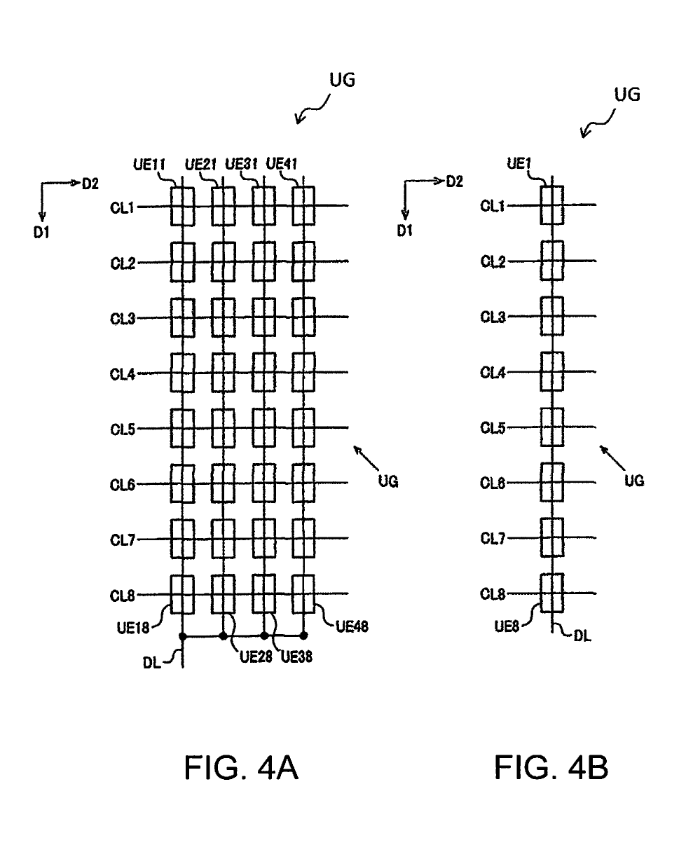

FIG. 4A shows an exemplary ultrasonic transducer element group UG (UG1 to UG64). In FIG. 4A, the ultrasonic transducer element group UG is constituted by first to fourth element columns. The first element column is constituted by ultrasonic transducer elements UE11 to UE18 that are disposed in the first direction D1, and the second element column is constituted by ultrasonic transducer elements UE21 to UE28 that are disposed in the first direction D1. The third element column (UE31 to UE38) and the fourth element column (UE41 to UE48) are also similarly constituted. The drive electrode line DL (DL1 to DL64) is commonly connected to the first to fourth element columns. Also, the common electrode lines CL1 to CL8 are connected to the ultrasonic transducer elements of the first to fourth element columns.

The ultrasonic transducer element group UG in FIG. 4A constitutes one channel of the ultrasonic transducer device. That is, the drive electrode line DL is equivalent to the drive electrode line of one channel, and the transmission signal of one channel from a transmission circuit is input to the drive electrode line DL. Also, the reception signal of one channel constituted by the ultrasonic transducer element group UG is output from the drive electrode line DL. Note that the number of element columns constituting one channel is not limited to four columns as shown in FIG. 4A, and may be less than four columns or greater than four columns. For example, one channel may be constituted by a single element column, as shown in FIG. 4B.

Returning to the description of FIG. 3, the drive electrode lines DL1 to DL64 (1st to mth drive electrode lines) are laid in the first direction D1. An ith drive electrode line DLi of the drive electrode lines DL1 to DL64 (where i is an integer such that 1≦i≦m) is connected to the lower electrode of the ultrasonic transducer elements UE of the ith ultrasonic transducer element group UGi.

Transmission signals VT1 to VT64 are supplied to the ultrasonic transducer elements UE via the drive electrode lines DL1 to DL64 in a transmission period for emitting ultrasonic waves. Also, reception signals VR1 to VR64 from the ultrasonic transducer elements UE are output via the drive electrode lines DL1 to DL64 in a reception period for receiving ultrasonic echo signals.

The common electrode lines CL1 to CL8 (1st to nth common electrode lines) are laid in the second direction D2. The second electrode of the ultrasonic transducer elements UE is connected to one of the common electrode lines CL1 to CL8. Specifically, as shown in FIG. 3, for example, a jth common electrode line CLj (where j is an integer such that 1≦j≦m) of the common electrode lines CL1 to CL8 is connected to the upper electrode of the ultrasonic transducer elements that are disposed in the jth line.

A common voltage V_{COM} is supplied to the common electrode lines CL1 to CL8. This common voltage V_{COM} need only be a constant direct current voltage, and not 0V, that is, not ground potential.

In the transmission period, a difference voltage between the transmission signal voltage and the common voltage is applied to the ultrasonic transducer elements UE, and ultrasonic waves of a predetermined frequency are emitted.

Note that the arrangement of the ultrasonic transducer elements UE is not limited to the matrix arrangement shown in FIG. 3, and may be in a so-called houndstooth arrangement in which the elements of any two adjacent columns are disposed so as to zigzag alternately. Also, in FIGS. 4A and 4B, the case is shown where a single ultrasonic transducer element is used as both a transmission element and a reception element, but the present embodiment is not limited thereto. For example, ultrasonic transducer elements for use as transmission elements and ultrasonic transducer elements for use as reception elements may be provided separately, and disposed in an array.

Also, the ultrasonic transducer elements 12 are not limited to a configuration that uses piezoelectric elements. For example, transducers that use capacitive elements, such as capacitive micro-machined ultrasonic transducers (cMUTs) may be employed, or bulk transducers may be employed.

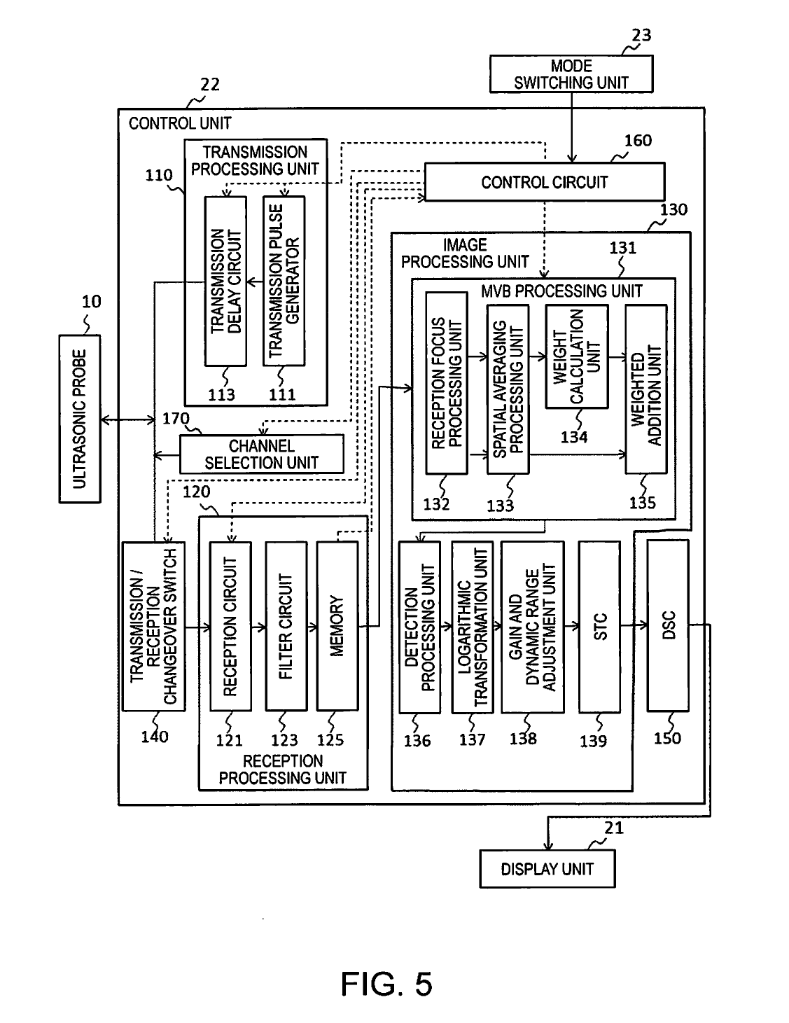

Returning to the description of FIG. 1, a display unit 21 is provided in the ultrasonic measurement apparatus main body 20. The display unit 21 displays image data for display generated by a control unit 22 (refer to FIG. 5). A liquid crystal display, an organic electroluminescence display or electronic paper, for example, can be used for the display unit 21.

FIG. 5 is a block diagram showing an exemplary functional configuration of the control unit 22 provided in the ultrasonic measurement apparatus main body 20. The control unit 22 includes a transmission processing unit 110, a reception processing unit 120, an image processing unit 130, a transmission/reception changeover switch 140, a digital scan converter (DSC) 150, a control circuit 160, and a channel selection unit 170. Note that, in the present embodiment, the control unit 22 is provided in the ultrasonic measurement apparatus main body 20, but may be provided in the ultrasonic probe 10.

The transmission processing unit 110 performs processing for transmitting ultrasonic waves toward an object. The transmission processing unit 110 includes a transmission pulse generator 111 and a transmission delay circuit 113.

The transmission pulse generator 111 applies a transmission pulse voltage to drive the ultrasonic probe 10.

The transmission delay circuit 113 performs transmission focusing control, and the ultrasonic probe 10 emits an ultrasonic beam corresponding to the generated pulse voltage toward the object. Thus, the transmission delay circuit 113 provides a time difference between channels with regard to the application timing of the transmission pulse voltage, and causes the ultrasonic waves produced by the plurality of vibration elements to converge. It is thus possible to arbitrarily change the focal length by changing the delay time.

In the case of linear scanning, the full aperture (64 channels in the example shown in FIG. 3) is divided, and transmission and reception is performed with the resultant apertures (use apertures) to generate individual lines. The eight elements constituting the use aperture among the 64 channels constituting the full aperture are changed over by a multiplexer (MUX) that is not illustrated. Specifically, the 1-8th, 2-9th, 3-10th, . . . , 57-64th channels are sequentially connected to the transmission processing unit 110 by the multiplexer (MUX). One line is then respectively formed by 1-8th, 2-9th, 3-10th, . . . , 57-64th channels. In the present embodiment, 57 lines are formed (i.e., 64 (total number of channels)−8 (number of channels of the use aperture)+1=57).

In the present embodiment, the transmission processing unit 110 transmits ultrasonic waves using all the channels of the use aperture (e.g., eight channels). This is because beam width narrows and azimuth resolution increases with enlargement of the use aperture. The full number of channels constituting the use aperture is equivalent to the first number of channels of the invention. (Note that processing at the time of reception differs from at the time of transmission in that at least a portion of the eight channels of the use aperture are used. This will be discussed in detail later.)

The transmission/reception changeover switch 140 performs changeover processing of ultrasonic wave transmission and reception. The transmission/reception changeover switch 140 protects the reception processing unit 120 from input of amplitude pulses at the time of transmission, and allows signals at the time of reception to pass through to the reception processing unit 120.

The reception processing unit 120 performs reception processing to acquire reception waves of ultrasonic echoes relating to a transmitted ultrasonic wave received by the ultrasonic probe 10 (hereinafter, reception waves). The reception processing unit 120 includes a reception circuit 121, a filter circuit 123, and a memory 125.

The reception circuit 121 converts the reception wave (analog signal) for each channel into a digital reception signal, and outputs the reception signal to the filter circuit 123. Note that processing for focusing the reception waves is performed with the image processing unit 130 which will be discussed later.

The filter circuit 123 performs filtering on the reception signal using a bandpass filter and removes noise.

The memory 125 is for storing reception signals output from the filter circuit 123, and the functions of the memory 125 can be realized by a HDD, a memory such as RAM, or the like.

The functions of the reception processing unit 120 can be realized by, for example, an analog front end (AFE) that is constituted by a low noise amplifier (LNA), a programmable gain amplifier (PGA), a filter unit, an analog/digital converter (A/D convertor), and the like.

Note that the configuration of the reception processing unit 120 is not restricted to the illustrated example. For example, the filter circuit 123 may be provided in the image processing unit 130 (discussed in detail later) or immediately before an MVB processing unit 131 (discussed in detail later). Also, the functions of the filter may be realized with software.

The image processing unit 130 processes the reception signal output from the reception processing unit 120. The image processing unit 130 primarily includes the MVB (minimum variance beamforming) processing unit 131, a detection processing unit 136, a logarithmic transformation unit 137, a gain and dynamic range adjustment unit 138, and a sensitivity time control (STC) 139.

The MVB processing unit 131 performs MVB processing, which is directionally-constrained adaptive beamforming. Adaptive beamforming is processing that involves dynamically changing the sensitivity characteristics so as to not have sensitivity to unwanted waves, by changing the weight of each channel according to the incoming wave. Even if an ultrasonic beam is transmitted so as to have high sound pressure in a frontal direction, ultrasonic waves also reach reflectors that exist in directions other than directly in front, since ultrasonic waves are characterized by spreading spherically. When unwanted waves reflected by reflectors other than the target are received, azimuth resolution deteriorates due to the influence of the unwanted waves. In contrast, adaptive beamforming places a constraint on direction so as to not have sensitivity to unwanted waves, thus enabling the problem of a decrease in azimuth resolution due to unwanted waves to be remedied.

The MVB processing unit 131 primarily includes a reception focus processing unit 132, a spatial averaging processing unit 133, a weight calculation unit 134, and a weighted addition unit 135.

The reception focus processing unit 132 performs processing for focusing reception waves. Specifically, the reception focus processing unit 132 provides a delay time Dₘ to the signal received by each channel so that the signals received by the respective channels are in phase, and computes the output signal of each channel after provision of the delay time. Since the reflective wave from a given reflector spreads spherically, a delay time is provided so that arrival time at the reception circuit 121 and at each vibrator is the same, and the reflective waves are added together taking into account the delay time.

In the case where the total number of channels is M, an output signal Xₘ of the mth channel is derived with equation (1). Also, the output signal of each channel is given by equation (2) when expressed in vector notation. Here, xₘ is the reception signal of the mth channel, and n shows the sample number (namely, depth in the image).

$$\begin{matrix}\text{?} = \text{?} [ n - \text{?} [ n ] ] & ( 1 ) \\ X [ n ] = [ \begin{matrix}{x}_{1} [ n - {D}_{1} [ n ] ] \\ {x}_{2} [ n - {D}_{2} [ n ] ] \\ ⋮ \\ {x}_{M} [ n - {D}_{M} [ n ] ]\end{matrix} ] \\ \text{?} \text{indicates text missing or illegible when filed} & ( 2 )\end{matrix}$$

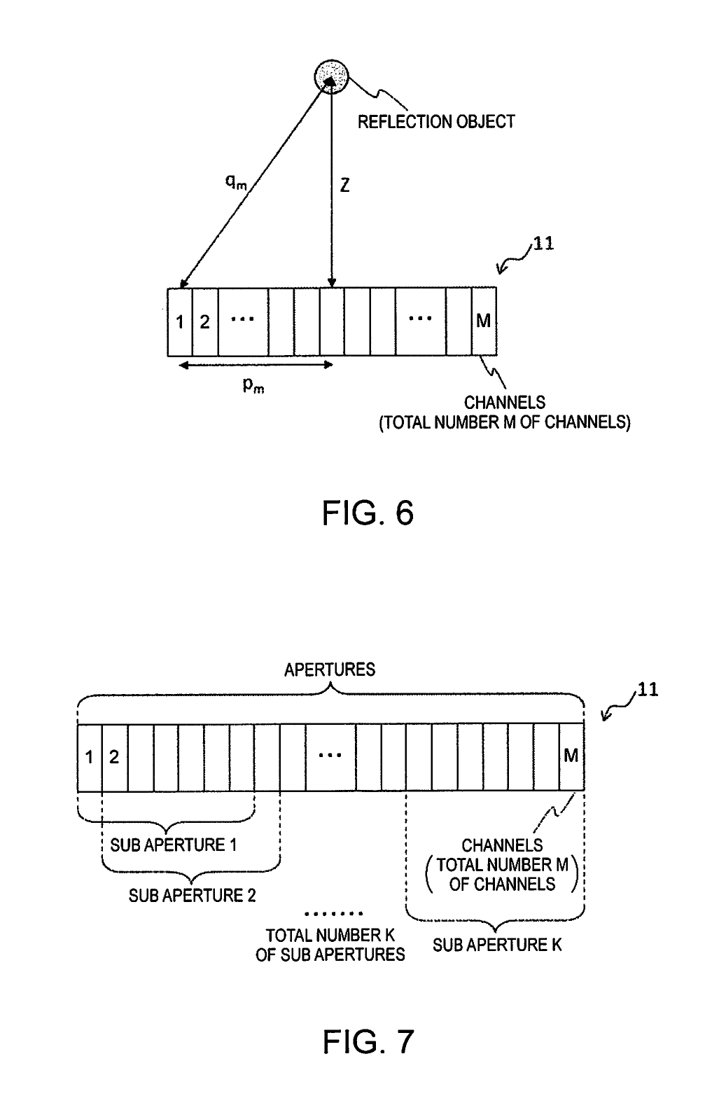

As shown in FIG. 6, the ultrasonic wave reflected from a reflection object (object) that is located in a depth direction Z from the ultrasonic transducer device 11 arrives at each channel as a spherical wave. Accordingly, the time taken for the reflection signal to arrive at the element of each channel is determined by a linear distance qₘ from the reflection object to the channel, with the ultrasonic wave taking longer to arrive as the distance of the element from the reflection object increases. An arrival time D′ₘ for each element depends on the linear distance from the object to each channel of the use aperture, and is determined geometrically, as shown in equation (3). pₘ is the position of the ultrasonic transducer element 12, Z is the depth distance, and c is the sound velocity (fixed value).

qₘ=\sqrt{pₘ²+Z²}

D′ₘ=qₘ/c (3)

Note that the reception focus processing is the same in the case of both the normal mode and the low power consumption mode (the normal mode and low power consumption mode will be discussed in detail later). The output signals computed by the reception focus processing unit 132 are output to the spatial averaging processing unit 133.

The spatial averaging processing unit 133 performs processing known as spatial averaging that involves extracting a plurality of sub apertures from the aperture constituted by the M channels and taking respective averages thereof. Spatial averaging is performed in order to prevent azimuth estimation accuracy from deteriorating due to the influence of correlated interference waves when the value of each channel is used directly.

For example, consider the case where K sub apertures (K=M−S+1) each consisting of S channels are extracted from the aperture of a total number of channels M, as shown in FIG. 7. In this case, the input vector of each sub aperture can be represented as shown in equation (4).

$$\text{?} [ n ] = [ \begin{matrix}\text{?} [ n - \text{?} [ n ] ] \\ \text{?} [ n - \text{?} [ n ] ] \\ ⋮ \\ \text{?} [ n - \text{?} [ n ] ]\end{matrix} ] \\ \text{?} \text{indicates text missing or illegible when filed} \qquad ( 4 )$$

Note that, instead of spatial averaging, processing known as temporal averaging that takes the average in a time direction of each channel may be performed. Signals processed by the spatial averaging processing unit 133 are output to the weight calculation unit 134 or the weighted addition unit 135.

Note that the spatial averaging processing unit 133 is not an essential constituent element. In the case where spatial averaging is not performed, signals processed by the reception focus processing unit 132 can be output to the weight calculation unit 134 or the weighted addition unit 135.

The weight calculation unit 134 computes the weight to be applied to the output of each channel, in the case of applying MVB processing. Here, weight calculation will be described.

First, the case where spatial averaging is not used will be described. An output z that is output by the weighted addition unit 135 is the result of multiplying a weight wₘ of each channel and a signal xₘ obtained from delay processing performed on each channel that is output from the reception focus processing unit 132 and summing the multiplication results, and is represented by equation (5).

$$z [ n ] = {\sum }_{m = 1}^{M} {w}_{m} [ n ] {x}_{m} [ n - {D}_{m} [ n ] ] \qquad ( 5 )$$

This is given by equations (6) and (7) when expressed in vector notation. H is a complex conjugate transpose and * is a complex conjugate.

$$\begin{matrix} z [ n ] = {w [ n ]}^{H} X [ n ] & ( 6 ) \\ w [ n ] = [ \begin{matrix}\text{?} \\ \text{?} \\ ⋮ \\ \text{?} [ n ]\end{matrix} ] \\ \text{?} \text{indicates text missing or illegible when filed} & ( 7 )\end{matrix}$$

A correlation matrix R is given by equations (8) and (9).

R[n]=E[X[n]X[n]^{T}] (8)

E└|z[n]|²┘=w[n]^{H}R[n]w[n] (9)

In order to compute a weight that minimizes the variance of z[n] in equations (8) and (9), conditional minimization problems such as shown in equations (10) and (11) are solved to derive the weight as shown in equation (12).

$$\begin{matrix}\text{?} {w [ n ]}^{H} R [ n ] w [ n ] & ( 10 ) \\ subject to {s [ n ]}^{H} a = 1 & ( 11 ) \\ w [ n ] = \frac{{R [ n ]}^{- 1} a}{{a}^{H} {R [ n ]}^{- 1} a} \\ \text{?} \text{indicates text missing or illegible when filed} & ( 12 )\end{matrix}$$

Here, a is a steering vector. In the present embodiment, phasing has already being performed, so the direction is 0 degrees. Accordingly, a can be set to 1.

Next, the case where spatial averaging is used will be described. The correlation matrix can be represented as shown in equation (13).

$$\tilde{R} [ n ] = \frac{1}{M - S + 1} \text{?} \text{?} [ n ] \text{?} [ n ] \\ \text{?} \text{indicates text missing or illegible when filed} \qquad ( 13 )$$

At this time, the optimal weight is derived by equation (14).

$$\text{?} [ n ] = \frac{{\tilde{R} [ n ]}^{- 1} a}{{a}^{H} {\tilde{R} [ n ]}^{- 1} a} \\ \text{?} \text{indicates text missing or illegible when filed} \qquad ( 14 )$$

The weighted addition unit 135 adds together the signals of the respective channels using the computed weights in the case where weights are computed by the weight calculation unit 134, and using weights computed in advance in the case where weights are not computed by the weight calculation unit 134. That is, an operation using equation (15) is performed to obtain the output z. The signal obtained from the adding by the weighted addition unit 135 is output to the detection processing unit 136. Note that the weights computed in advance may be a fixed value or may be weight that depends on the number of scan lines, the distance from the object to the channel, or the like. This weight does not, however, vary with the size of the reception signal.

$$z [ n ] = \frac{1}{M - S + 1} \text{?} \text{?} \text{?} [ n ] \\ \text{?} \text{indicates text missing or illegible when filed} \qquad ( 15 )$$

The detection processing unit 136 performs absolute value (rectification) processing, and thereafter applies a low-pass filter to extract an unmodulated signal.

The logarithmic transformation unit 137 performs Log compression on the extracted unmodulated signal, and converts the form of expression of the signal, so as to more easily confirm the maximum and minimum signal strengths of reception signals at the same time.

The gain and dynamic range adjustment unit 138 adjusts the signal strength and the area of interest. Specifically, in gain adjustment processing, a direct current component is added to the Log-compressed input signal. Also, in dynamic range adjustment processing, the Log-compressed input signal is multiplied by an arbitrary number.

The STC 139 corrects the degree of amplification (brightness) according to depth, and acquires an image having uniform brightness across the entire screen.

Note that the functions of the image processing unit 130 can be realized by hardware such as various processors (CPU, etc.), an ASIC (gate array, etc.) and the like, computer programs, or the like.

The DSC 150 performs scan conversion on B-mode image data. For example, the DSC 150 converts line signals into image signals by interpolation processing such as bilinear interpolation. The DSC 150 then performs scan conversion on the B-mode image data. The DSC 150 outputs the image signals to the display unit 21. Images are thereby displayed on the display unit 21.

The control circuit 160 performs control of the transmission pulse generator 111, the transmission delay circuit 113, the reception circuit 121, the transmission/reception changeover switch 140, and the MVB processing unit 131.

Also, a mode switching unit 23 (refer to FIG. 5) is provided in the ultrasonic measurement apparatus main body 20. The mode switching unit 23, upon information showing the operating mode (the normal mode and the low power consumption mode will be described in detail later) of the ultrasonic measurement apparatus 1 being input via an input unit that is not illustrated, for example, receives the information showing the operating mode and inputs this information to the control circuit 160. Here, the information showing operating mode is information showing the normal mode and low power consumption mode.

The channel selection unit 170 acquires the information showing operating mode from the control circuit 160, and selects channels to be used for reception of ultrasonic echoes based on this information. The channel selection unit 170 acquires reception waves from all the channels of the use aperture, when information showing the normal mode is acquired, and selects channels to be used so that reception waves are acquired from at least a portion of the full number of channels of the use aperture, when information showing the low power consumption mode is acquired. The channel selection unit 170 will be described in detail later.

Although the main configuration of the ultrasonic measurement apparatus 1 has been described above in describing the features of the present embodiment, the configuration of the ultrasonic measurement apparatus 1 is not limited to the above configuration. The instant invention is not restricted by the classification method or names of the constituent elements. The configuration of the ultrasonic measurement apparatus 1 can also be classified into more constituent elements according to the processing content. One constituent element can also be classified so as to execute more processing. Also, the processing of each constituent element may be executed by one piece of hardware or may be executed by multiple pieces of hardware.

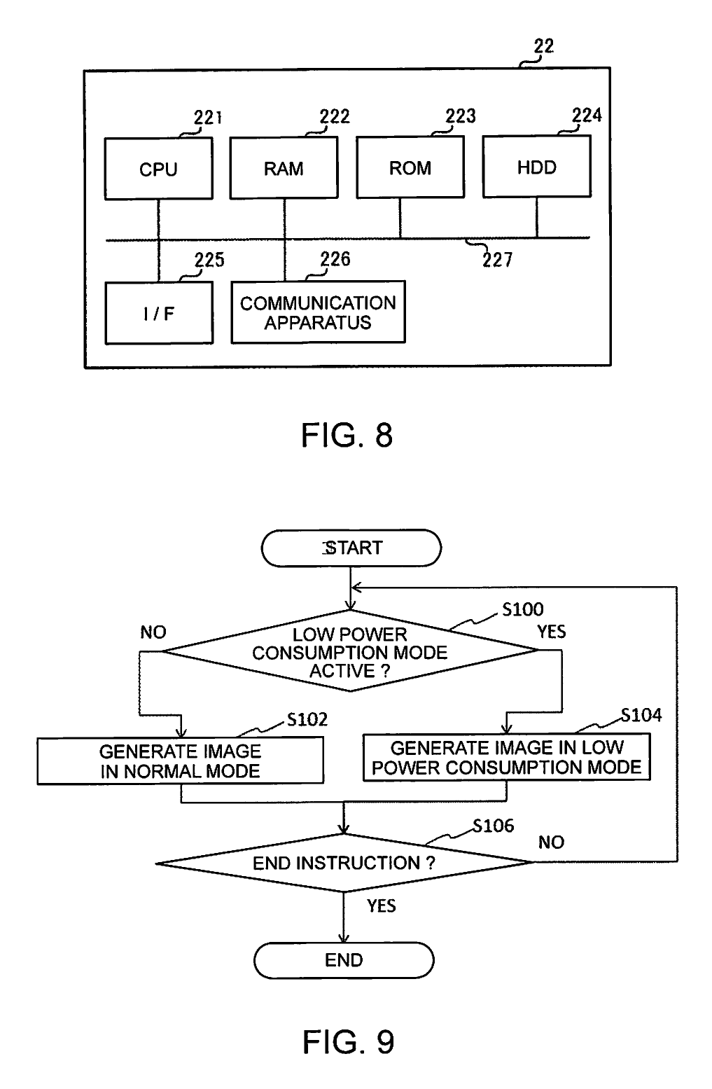

FIG. 8 is a block diagram showing an exemplary schematic configuration of at least a portion of the control unit 22. As shown in the diagram, the control unit 22 is provided with a central processing unit (CPU) 221 which is an arithmetic device, a random access memory (RAM) 222 which is a volatile storage device, a read only memory (ROM) 223 which is a nonvolatile storage device, a hard disk drive (HDD) 224, an interface (I/F) circuit 225 that connects the control unit 22 with other units, a communication apparatus 226 that performs communication with external devices, and a bus 227 that connects these constituent elements with each other.

Each of above functional units is realized by the CPU 221 reading out a predetermined program stored in the ROM 223 to the RAM 222 and executing the read program. Note that the predetermined programs may, for example, be installed in the ROM 223 in advance, or may be downloaded from a network via the communication apparatus 226 and installed or updated.

Next, processing by the ultrasonic measurement apparatus 1 of the present embodiment having the above configuration will be described. The ultrasonic measurement apparatus 1 is characterized in that the number of channels that are used and the beamforming processing differ according to the mode.

FIG. 9 is a flowchart showing processing for judging the current ultrasonic measurement apparatus 1. The control circuit 160 judges whether the low power consumption mode is active, based on information showing the operating mode input from the mode switching unit 23 (step S100).

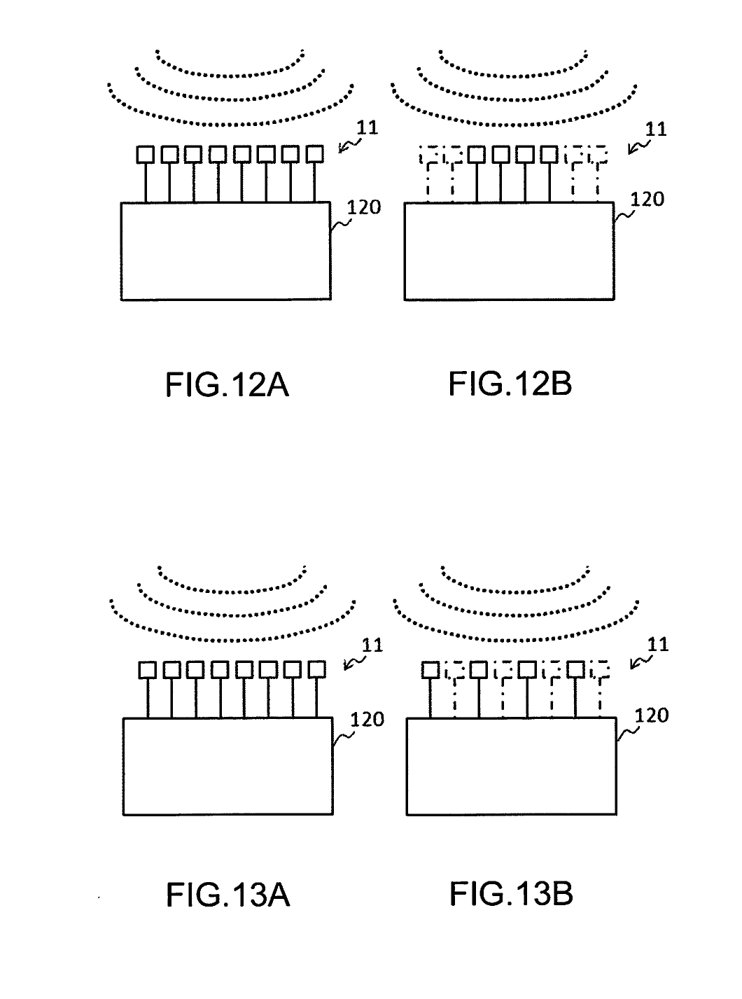

Here, the operating modes in the present embodiment will be described. In the present embodiment, a normal mode in which normal processing using all the channels of the use aperture is performed (refer to FIGS. 12A and 13A; described in detail later), and a low power consumption mode in which processing is performed using at least a portion of the channels of the use aperture (refer to FIGS. 12B and 13B; described in detail later) can be set.

In the case of an ultrasonic diagnostic apparatus that performs digital processing, the high power consumption of the AFE (equivalent to the reception processing unit 120) that performs processing for converting analog signals to digital signals is an issue. Accordingly, in the low power consumption mode, power consumption is reduced by reducing the number of signals input to the AFE.

However, there is a problem in that simply reducing the number of signals input to the AFE, that is, the number of channels, results in a decreases in image quality. Therefore, in the present embodiment, image quality is improved by performing MVB processing in the low power consumption mode.

If the low power consumption mode is not active (NO at step S100), that is, if the information showing the operating mode input from the mode switching unit 23 is information showing the normal mode, the control circuit 160 performs processing in the normal mode in which reception focusing is performed using the signals of all the channels of the use aperture (step S102).

If the low power consumption mode is active (YES at step S100), that is, if the information showing the operating mode input from the mode switching unit 23 is information showing the low power consumption mode, the control circuit 160 performs processing in the low power consumption mode in which reception focusing is performed using the signals of at least a portion of the channels of the use aperture, and performs MVB processing (step S104).

The control circuit 160 judges whether a processing end instruction has been input via the input unit or the like that is not illustrated (step S106). If a processing end instruction has not been input (NO at step S106), the processing returns to step S100, if a processing end instruction has been input (YES at step S106), the processing is ended.

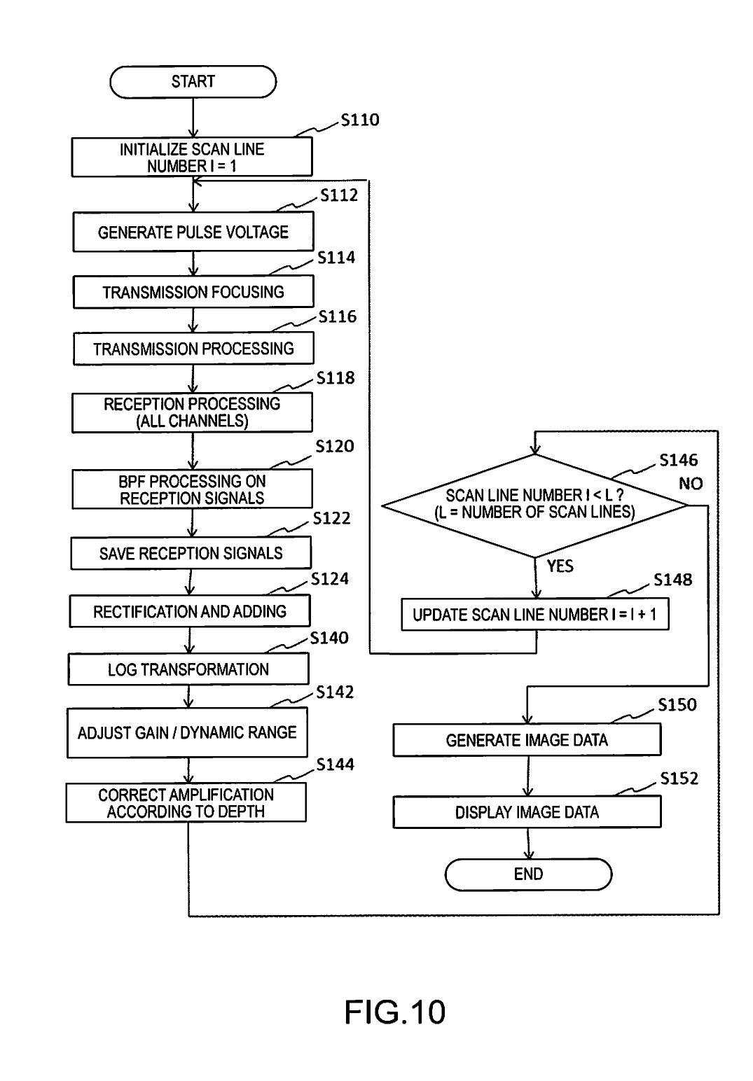

Next, image generation processing in the case of both the normal mode and the low power consumption mode will be described. FIG. 10 is a flowchart showing the flow of image generation processing in the normal mode.

The control circuit 160 initializes the scan line number l which is a number showing the line for generating an image to 1 (l=1) (step S110). The scan line number l is a number showing one of the ultrasonic transducer element groups UG1 to UG64 constituting an ultrasonic transducer device such as shown in FIG. 3. For example, the scan line number l of an element group provided at a given end, here, the ultrasonic transducer element group UG1, is set to 1. Also, the scan line number l of the element group that is adjacent to the element group having the scan line number 1, here, the ultrasonic transducer element group UG2, is set to 2. The scan line number l is given to all the element groups in this way. The relationship between the ultrasonic transducer element groups UG1 to UG64 and the scan line number l can be stored in a memory such as the ROM.

The control circuit 160 performs transmission of an ultrasonic pulse from all the channels of the use aperture corresponding to the channel having the scan line number l initialized at step S110 or the scan line number l updated at step S148 which will be discussed later (steps S112 to S116). For example, the channels at the time of the scan line number 1 are the ultrasonic transducer element groups UG1 to UG8, and the channels at the time of the scan line number 2 are the ultrasonic transducer element groups UG2 to UG9.

Specifically, the transmission pulse generator 111 generates a pulse voltage for transmitting an ultrasonic pulse having a frequency f (f can take any given value) (step S112). The transmission delay circuit 113 performs transmission focusing control (step S114), and the ultrasonic probe 10 emits an ultrasonic beam corresponding to the pulse voltage generated at step S112 toward the object (step S116).

Next, the control circuit 160 performs transmission/reception changeover processing via the transmission/reception changeover switch 140. The ultrasonic probe 10 receives the reception waves that come back as a result of the emitted ultrasonic beam being reflected by the object with all the channels of the use aperture, and passes the received signals to the reception processing unit 120. The reception circuit 121 converts the reception wave (analog signal) for each channel into a digital reception signal, and outputs the reception signals to the filter circuit 123 (step S118).

The filter circuit 123 performs bandpass filtering on the reception signals (step S120). The control circuit 160 saves the signals output from the filter circuit 123 to the memory 125 (step S122).

The MVB processing unit 131 performs processing for rectifying and adding together the signals saved in the memory 125 (step S124). Specifically, the reception focus processing unit 132 derives the output signal of each channel after provision of a delay time that depends on the linear distance from the object to the each channel of the use aperture, and the spatial averaging processing unit 133 performs spatial averaging on the output signal of each channel derived by the reception focus processing unit 132. The weighted addition unit 135 then adds together the signals of the ultrasonic transducer elements 12 using weights set in advance.

The logarithmic transformation unit 137 performs logarithmic transformation on the result of adding together the signals of the channels of the use aperture (step S140). The gain and dynamic range adjustment unit 138 adjusts the signal strength and the area of interest (step S142). The STC 139 corrects the degree of amplification (brightness) according to depth (step S144).

The control circuit 160 judges whether the scan line number l showing the line for generating an image is less than the number L of scan lines (step S146). The number L of scan lines is the number of ultrasonic transducer element groups UG1 to UG64 constituting an ultrasonic transducer device 11 such as shown in FIG. 3, with L being 64 in the example shown in FIG. 3.

If the scan line number l is less than the number L of scan lines (YES at step S146), the control circuit 160 adds 1 to the current scan line number l to update the scan line number l, and returns the processing to step S112 (step S198).

If the scan line number l is not less than the number L of scan lines (NO at step S146), the scan line number l matches the number L of scan lines, that is, transmission and reception of ultrasonic pulses has ended for all the lines. In this case, the DSC 150 performs scan conversion to generate B-mode image data (image data for display), and outputs the generated image data for display to the display unit 21 (step S150). The display unit 21 displays the generated image data for display (step S152). This ends the processing shown in FIG. 10.

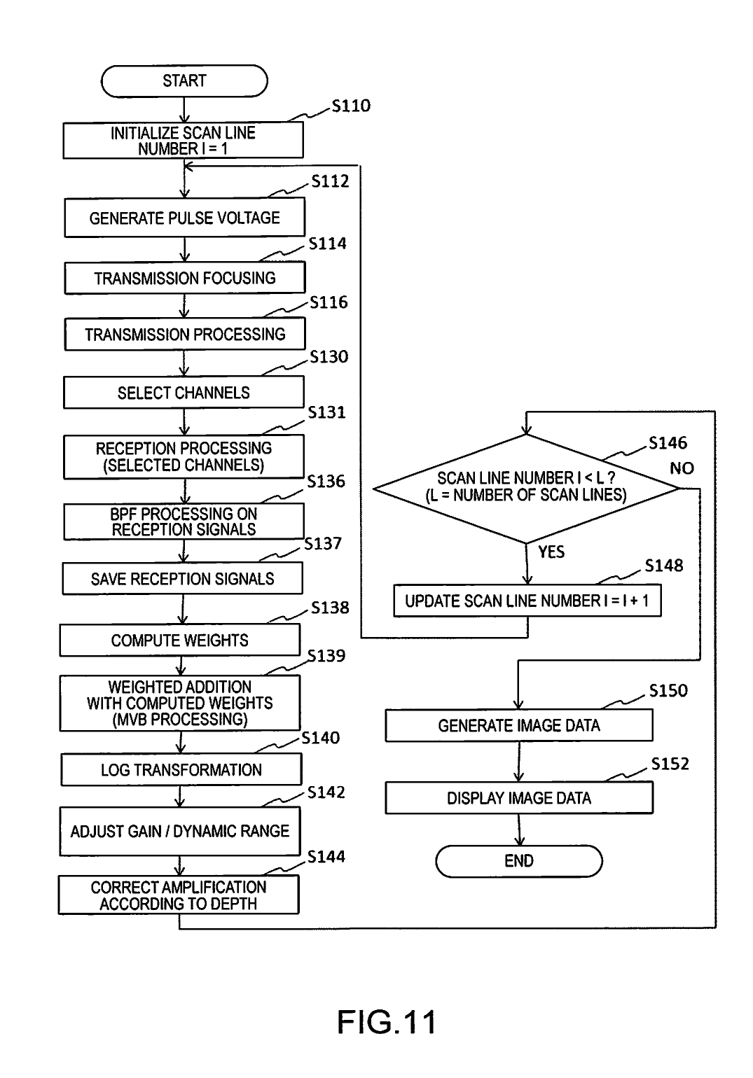

FIG. 11 is a flowchart showing the flow of image generation processing in the low power consumption mode. Note that the same signs are given to portions that are the same portion as processing shown in FIG. 10, and a detailed description thereof will be omitted.

The control circuit 160 initializes the scan line number l to 1 (l=1) (step S110).

The control circuit 160 performs transmission of ultrasonic pulses from all the channels of the use aperture corresponding to the channel having the scan line number l initialized at step S110 or the scan line number l updated at step S148 which will be discussed later (steps S112 to S116).

Next, the channel selection unit 170 selects channels to be used for reception of ultrasonic echoes reflected by the object, from among all the channels of the use aperture from which ultrasonic pulses were transmitted at steps S112 to S116 (step S130). Note that the channels selected by the channel selection unit 170 are equivalent to the second number of channels of the invention. Hereinafter, selection of channels will be described in detail.

FIGS. 12A and 12B and FIGS. 13A and 13B illustrate the use configuration of the channels included in the use aperture, with FIGS. 12A and 13A showing the case of the normal mode, and FIGS. 12B and 13B showing the case of the low power consumption mode. In the case of the normal mode, all the channels are used. In contrast, since power consumption is reduced in the case of the low power consumption mode, the number of signals input to the AFE, that is, the number of channels, is reduced.

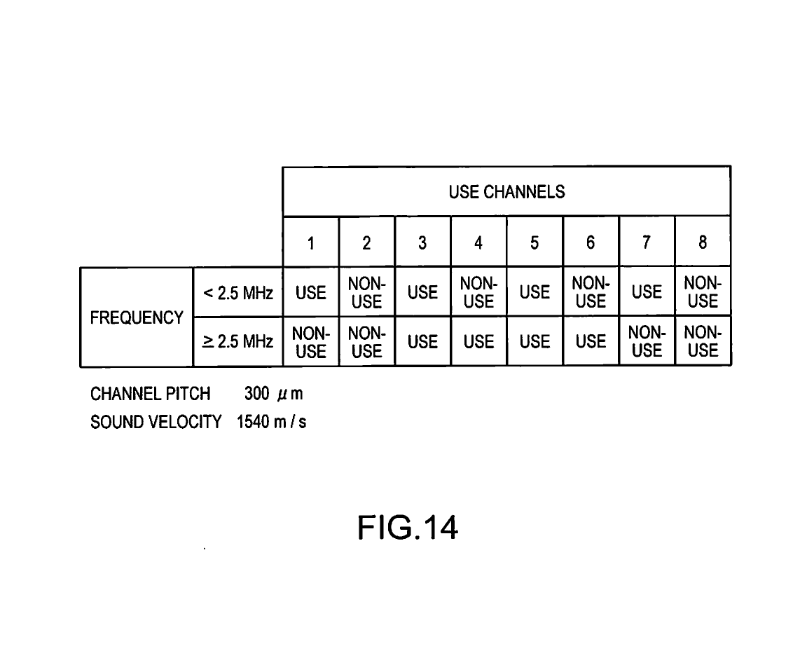

FIG. 14 is a channel selection table showing the relationship between frequency when the interval of the distance (element pitch) between adjacent channels is 300 μm and channels to be used. This table is stored in the ROM 223, for example. The channel selection unit 170 selects the channels to be used, based on the wavelength of ultrasonic waves that are transmitted, and the channel selection table stored in the ROM 223.

The transmission frequency is often changed when using the ultrasonic measurement apparatus 1. Although resolution increases with an increase in frequency, observation depth decreases. Accordingly, the user of the ultrasonic measurement apparatus 1 selects an optimal frequency to use depending on the depth of the site to be observed. However, the appropriate method for preventing the occurrence of grating lobes which cause image quality deterioration differs depending on the frequency. Accordingly, the channel selection unit 170 stores information showing the relationship between frequency and channels to be used, and channels to be used can be selected based on this information.

Note that the information showing relationship between frequency and channels to be used is not limited to the channel selection table shown in FIG. 14.

FIG. 12B shows the case where the frequency in FIG. 14 is greater than or equal to 2.5 MHz. In the case where frequency is high, a portion of the channels are selected, so that the element pitch does not change. In FIG. 12B, the channel selection unit 170 selects a portion (e.g., four) of the channels that are located in a central portion of the use aperture as channels to be used. Note that it is not essential to select the elements that are located in a central portion of the use aperture, and channels that are located at the edge of the use aperture may be selected.

FIG. 13B shows the case where the frequency in FIG. 14 is less than 2.5 MHz. The appearance of grating lobe is determined by a wavelength λ (sound velocity/frequency) of the transmission wave and the element pitch. Generally, in the case where ultrasonic waves are transmitted and received in a range of 180 degrees, grating lobes will be suppressed if the element pitch is less than λ/2. Accordingly, the channel selection unit 170 selects channels to be used such that, in the case where the frequency is low, the interval between selected channels is the largest interval that satisfies the condition of being less than λ/2. In FIG. 13B, the channels to be used are selected every other channel.

By thus reducing the number of channels to be used, the number of signals that are input to the reception processing unit 120, that is, the number of drives of the AFE which has high power consumption, can be reduced, enabling low power consumption to be achieved. Note that although, in the present embodiment, channels to be used were selected based on a channel selection table, the method of selecting channels to be used is not limited thereto. Note also that even when the signals of at least a portion of the channels of the use aperture are passed to the AFE, one line is formed, similarly to the case where all the channels are used.

Returning to the description of FIG. 11, the control circuit 160 performs processing for changing over transmission/reception via the transmission/reception changeover switch 140. The ultrasonic probe 10 receives the reception waves that come back as a result of the emitted ultrasonic beam being reflected by the object. The transmission/reception changeover switch 140 passes only the signals received by the channels selected at step S130 to the reception processing unit 120. The reception circuit 121 then converts the reception wave (analog signal) for each channel into a digital reception signal, and outputs the reception signals to the filter circuit 123 (step S131).

The filter circuit 123 performs bandpass filtering on the reception signals (step S136). The control circuit 160 saves the signals output from the filter circuit 123 to the memory 125 (step S137). This processing is the same as the processing of steps S120 and S122.

The MVB processing unit 131 performs so-called MVB processing on the signals saved in the memory 125, which involves computing weights that differ for each channel, and performing weighted addition using the computed weights (steps S138 and S139). Specifically, the reception focus processing unit 132 provides a delay time to the signal received by each channel, so that the signals received by the respective channels are in phase, and computes an output signal of each channel after provision of the delay time. The spatial averaging processing unit 133 performs spatial averaging on the output signals computed by the reception focus processing unit 132. The weight calculation unit 134 then computes a weight to be applied to the output of each ultrasonic transducer element 12 (step S138).

The weighted addition unit 135 then adds together the signals of the respective channels, using the weights computed at step S138 (step S139). This ends the MVB processing.

The logarithmic transformation unit 137 performs logarithmic transformation on the result of having added the signals of the respective channels (step S140). The gain and dynamic range adjustment unit 138 adjusts the signal strength and the area of interest (step S142). The STC 139 corrects the degree of amplification (brightness) according to depth (step S144).

The control circuit 160 judges whether the scan line number l of the ultrasonic transducer element group targeted for processing in steps S112 to S144 is less than the number L of scan lines (step S146). The number L of scan lines depends on the number of ultrasonic transducer element groups UG1 to UG64 constituting an ultrasonic transducer device such as shown in FIG. 3.

If the scan line number l is less than the number L of scan lines (YES at step S146), the control circuit 160 adds 1 to the current scan line number l to update the scan line number l, and returns the processing to step S112 (step S148).

If the scan line number l is not less than the number L of scan lines (NO at step S146), the scan line number l matches the number L of scan lines, that is, the transmission and reception of ultrasonic pulses has ended in all the ultrasonic transducer element groups UG. In this case, the DSC 150 performs scan conversion to generate B-mode image data (image data for display), and outputs the generated image data for display to the display unit 21 (step S150). The display unit 21 displays the generated image data for display (step S152). This ends the processing shown in FIG. 10.

According to the present embodiment, power consumption in the low power consumption mode can be suppressed by reducing the number of drives of the reception processing unit, that is, the AFE. Also, since MVB processing is performed in the low power consumption mode, image quality degradation due to reducing the number of channels can be suppressed.

Also, according to the present embodiment, B-mode images can be displayed in the normal mode, enabling compatibility with a conventional ultrasonic measurement apparatus to be maintained.

Also, according to the present embodiment, appropriate channels are selected in the low power consumption mode depending on the frequency, enabling the occurrence of grating lobes to be effectively suppressed.

Note that, in the present embodiment, since linear scanning was described as an example, channels to be used were selected from among the eight channels of the use aperture in the low power consumption mode. In contrast, in the case of sector scanning, the full aperture is used (the use aperture consists of 64 channels), and lines are generated while changing the beam direction. Accordingly, as long as a configuration is adopted in which channels to be used are selected from the full aperture (e.g., 64 channels), the present embodiment can be applied to sector scanning.

### Second Embodiment

Although the ultrasonic measurement apparatus 1 according to the first embodiment reduces the number of channels by using a portion of the channels and inputs the signals of the channels that are used to the reception processing unit in the low power consumption mode, the method of reducing the number of signals that are input to the reception processing unit is not limited thereto.

An ultrasonic measurement apparatus 2 according to the second embodiment reduces the number of signals that are input to the reception processing unit by adding together the signals of a plurality of channels and inputting the resultant signal to the reception processing unit. Hereinafter, the ultrasonic measurement apparatus 2 will be described.

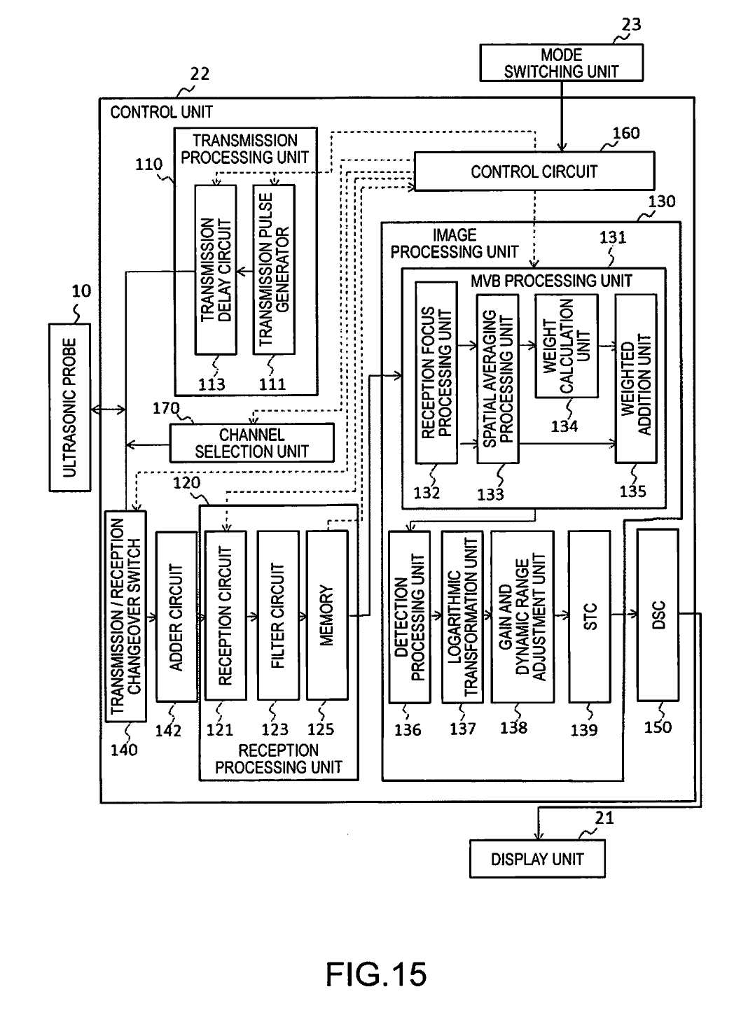

FIG. 15 is a block diagram showing an exemplary functional configuration of a control unit 22 provided in an ultrasonic measurement apparatus main body 20 of the ultrasonic measurement apparatus 2. Since a difference between the configuration of the ultrasonic measurement apparatus 2 and the configuration of the ultrasonic measurement apparatus 1 is that the ultrasonic measurement apparatus 2 has adder circuits 142, whereas the ultrasonic measurement apparatus 1 does not have adder circuits, the adder circuits 142 will be described here. The same signs are given to portions that are the same as the configuration of the ultrasonic measurement apparatus 1, and a detailed description thereof will be omitted.

The adder circuits 142 are provided between the transmission/reception changeover switch 140 and the reception processing unit 120. The adder circuits 142 add together the reception signals received by a plurality of channels, and input the resultant signal to the reception processing unit 120 as the reception signal of one channel. The channels that input to the adder circuits 142 are selected by the channel selection unit 170. The adder circuits 142 will be discussed in detail later.

Hereinafter, the processing that is performed by the ultrasonic measurement apparatus 2 will be described. Since the processing that is performed by the ultrasonic measurement apparatus 1 and the processing that is performed by the ultrasonic measurement apparatus 2 differ in the case of the low power consumption mode, the processing that is performed by the ultrasonic measurement apparatus 2 in the case of the low power consumption mode will be described. Note that the same signs are given to portions that are the same as processing by the ultrasonic measurement apparatus 1, and a detailed description thereof will be omitted.

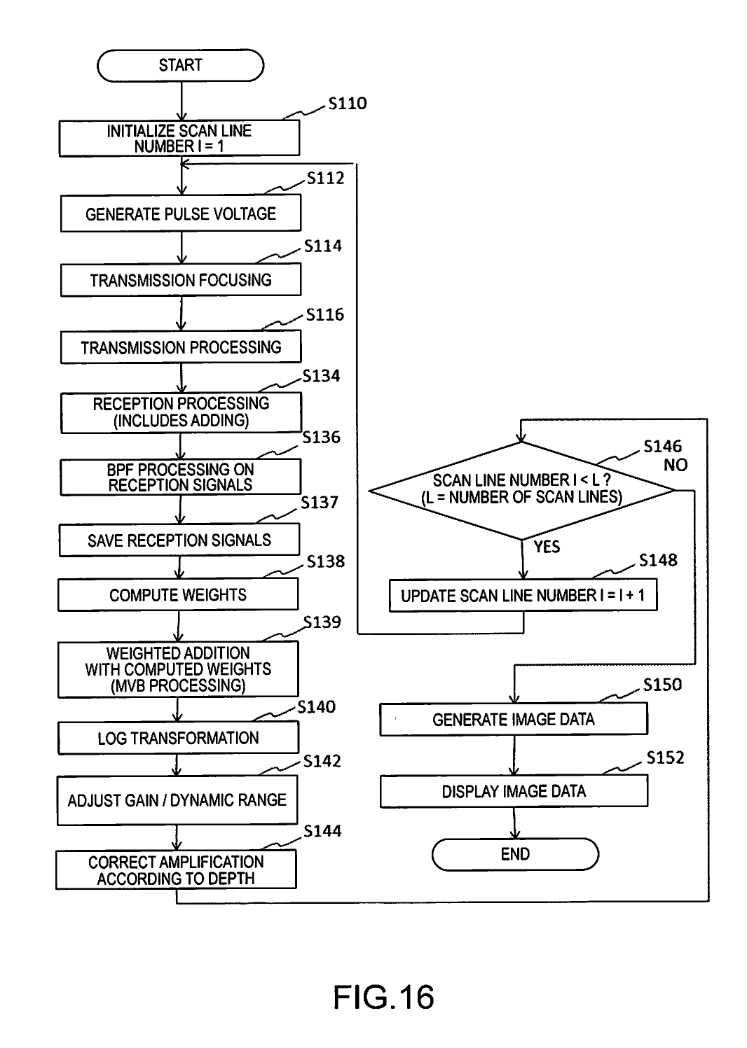

FIG. 16 is a flowchart showing the flow of image generation processing in the low power consumption mode.

The control circuit 160 initializes the scan line number l to 1 (l=1) (step S110).

The control circuit 160 performs transmission of an ultrasonic pulse from all the channels of the use aperture corresponding to the channel having the scan line number l initialized at step S110 or the scan line number l updated at step S148 which will be discussed later (steps S112 to S116).

Next, reception processing is performed (step S134). Hereinafter, the processing of step S134 will be described.

The control circuit 160 performs processing for changing over transmission/reception via the transmission/reception changeover switch 140. The ultrasonic probe 10 receives the reception waves that come back as a result of the emitted ultrasonic beam being reflected by the object. The channel selection unit 170 passes the signals received by the selected channels (here, all the channels) two at a time to one adder circuit 142, and the adder circuit 142 adds together the signals of the plurality (here, two) of channels and passes the resultant signal to the reception processing unit 120.

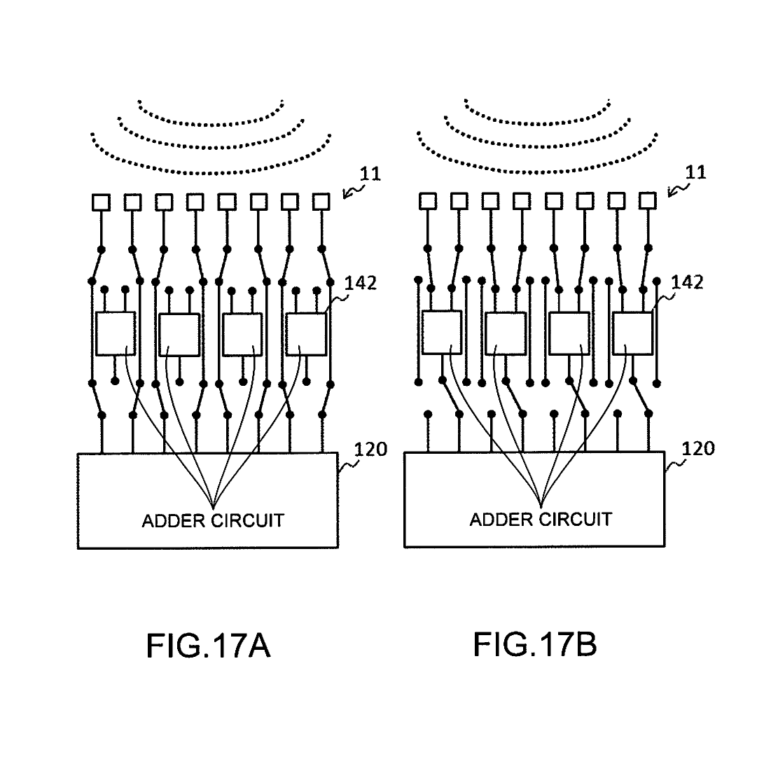

FIGS. 17A and 17B illustrate the adding of the reception signals of a plurality of channels by the adder circuits 142, with FIG. 17A showing the case where the adder circuits 142 do not add the signals, that is, the case of the normal mode, and FIG. 17B showing the case where the adder circuits 142 add together the reception signals of two channels, that is, the case of the low power consumption mode.

In the case shown in FIG. 17A, the reception signal of each channel is input directly to the reception processing unit 120, without passing through the adder circuits 142. This is the same as the case shown in FIGS. 12A and 13A.

In the case shown in FIG. 17B, the adder circuits 142 add together the signals of two adjacent channels, and the resultant signal is input to the reception processing unit 120 as the signal of one channel. Accordingly, the reception signals received by eight channels are input to the reception processing unit 120 as reception signals received by four channels. The number of channels is thereby reduced in a pseudo manner, and the number of signals that are input to the reception processing unit 120 is reduced.

Also, in the case shown in FIG. 17B, the signals obtained from the adding by the adder circuits 142 are input to the reception processing unit 120 as the signal received by one of the two channels which received the signals that were added (right-hand channel in FIG. 17B). Channels are thereby selected.

By thus reducing the number of signals that are input to the reception processing unit 120, the number of drives of the AFE having high power consumption can be reduced, enabling low power consumption to be achieved. Also, since the sound pressure of the signals that are input can be maintained by adding the signals together, reception sensitivity can be maintained.

Note that although, in FIG. 17B, the reception signals of all the channels are input to the adder circuits 142, the signals of all the channels do not necessarily need to be added together, and the reception signals of at least a portion of the channels may be input to the adder circuits 142. For example, the signals of the four channels in the center of the use aperture may be input directly to the reception processing unit 120, and the two channels at either edge of the use aperture, that is, four channel in total, may be respectively input to the reception processing unit 120 by the adder circuits 142 as the signal of one channel.

Also, although, in FIG. 17B, the signals of two channels are input to one adder circuit 142, the signals of three or more channels may be input to one adder circuit 142.

Also, in FIG. 17B, the element pitch is widened by adding together the signals of a plurality of channels. The number of channels that input to one adder circuit 142 may also be set according to the frequency of the ultrasonic wave that is transmitted, so that the grating lobes do not occur.

The reception circuit 121 then converts the reception wave (analog signal) for each channel into a digital reception signal, and outputs the reception signals to the filter circuit 123.

The filter circuit 123 performs bandpass filtering on the reception signals (step S136). The control circuit 160 saves the signals output from the filter circuit 123 to the memory 125 (step S137). This processing is the same as the processing of steps S120 and S122.

The MVB processing unit 131 performs so-called MVB processing on the signals saved in the memory 125, which involves computing weights that differ for each ultrasonic transducer element 12, and performing weighted addition using the computed weights (steps S138 to S139).

The logarithmic transformation unit 137 performs logarithmic transformation on the result of having added together the signals of the ultrasonic transducer elements 12 (step S140). The gain and dynamic range adjustment unit 138 adjusts the signal strength and the area of interest (step S142). The STC 139 corrects the degree of amplification (brightness) according to depth (step S144).

The control circuit 160 judges whether the scan line number l of the ultrasonic transducer element group targeted for processing in steps S112 to S144 is less than the number L of scan lines (step S146).

If the scan line number l is less than the number L of scan lines (YES at step S146), the control circuit 160 adds 1 to the current scan line number l to update the scan line number l, and returns the processing to step S112 (step S148).

If the scan line number l is not less than the number L of scan lines (NO at step S146), the scan line number l matches the number L of scan lines, that is, transmission and reception of ultrasonic pulses has ended for all the ultrasonic transducer element groups UG. In this case, the DSC 150 performs scan conversion to generate B-mode image data (image data for display), and outputs the generated image data to the display unit 21 (step S150). The display unit 21 displays the generated image data for display (step S152). This ends the processing shown in FIG. 10.

According to the present embodiment, power consumption can be suppressed in the low power consumption mode by reducing the number of drives of the reception processing unit 120, that is, the AFE, similarly to the first embodiment. Also, since MVB processing is performed in the low power consumption mode, image quality degradation due to a reduction in the number of ultrasonic transducer element 12 can be suppressed.

Also, according to the present embodiment, addition processing is performed to reduce the number of signals that are input to the reception processing unit, the sound pressure of the signals can be maintained, and accordingly reception sensitivity can be maintained.

Although the invention has been described above using embodiments, the technical scope of the invention is not limited to the scope given in the above embodiments. A person skilled in the art will appreciate that numerous changes and modifications can be made to the embodiments. Also, it is obvious from the claims that configurations to which changes and modifications are made are included in the technical scope of the invention. Also, the invention is not limited to an ultrasonic measurement apparatus, and can also be provided as an image processing method that is performed in an ultrasonic measurement apparatus, a program that causes an ultrasonic measurement apparatus to perform image processing, a storage medium on which the program is stored, or the like.

The entire disclosure of Japanese Patent Application No. 2013-183799, filed Sep. 5, 2013 is expressly incorporated by reference herein.

What is claimed is:

1. An ultrasonic measurement apparatus comprising:
a reception processing unit that performs, when information showing a normal mode or a low power consumption mode shows the normal mode, processing for receiving a first number of ultrasonic echoes from among ultrasonic echoes relating to a transmitted ultrasonic wave that are acquired from channels constituted by ultrasonic transducer elements that transmit and receive the ultrasonic wave, that performs, when the information shows the low power consumption mode, processing for receiving a second number of ultrasonic echoes that is less than the first number from among the ultrasonic echoes relating to the transmitted ultrasonic wave that are acquired from the channels, and that outputs reception signals obtained from the reception processing; and
an image processing unit that receives the reception signals output from the reception processing unit, that adds together the first number of the reception signals with a weight that is computed in advance and performs image generation based on the reception signal obtained from the adding, when the information shows the normal mode, and that adds together the second number of the reception signals with a weight that depends on each reception signal and performs image generation based on the reception signal obtained from the adding, when the information shows the low power consumption mode.

2. The ultrasonic measurement apparatus according to claim 1, further comprising:
a channel selection unit that selects channels to be used so as to acquire, from the first number of the channels, ultrasonic echoes relating to the transmitted ultrasonic wave, when the information shows the normal mode, and to acquire, from the second number of the channels, ultrasonic echoes relating to the transmitted ultrasonic wave, when the information shows the low power consumption mode.

3. The ultrasonic measurement apparatus according to claim 2,
wherein the channel selection unit, when the information shows the low power consumption mode, selects the second number of channels that are located in a central portion of the first number of channels.

4. The ultrasonic measurement apparatus according to claim 2,
wherein the channel selection unit, when the information shows the low power consumption mode, selects the second number of channels such that an interval between adjacent channels in the second number of channels is a largest interval that satisfies a condition of being less than half the wavelength of the transmitted ultrasonic wave.

5. The ultrasonic measurement apparatus according to claim 2,
wherein the channel selection unit acquires information showing a relationship between a frequency of the transmitted ultrasonic wave and the second number of channels, and selects a location of the second number of channels based on the acquired information.

6. The ultrasonic measurement apparatus according to claim 1, further comprising:
a channel selection unit that, when the information shows the low power consumption mode, adds together the signals acquired by a plurality of channels among the first number of channels to serve as the signal of one channel.

7. The ultrasonic measurement apparatus according to claim 1,
wherein the image processing unit derives the weight that depends on each reception signal, so as to minimize a variance of a result of multiplying the reception signal after a delay time that depends on a linear distance from an object to each channel by the weight that depends on the reception signal.

8. The ultrasonic measurement apparatus according to claim 6,
wherein the image processing unit, when the information shows the low power consumption mode, derives the weight that depends on each reception signal after extracting a plurality of sub apertures from an aperture constituted by the second number of channels and taking respective averages thereof.

9. The ultrasonic measurement apparatus according to claim 6,
wherein the image processing unit, when the information shows the low power consumption mode, derives the weight that depends on each reception signal after extracting, from the second number of the reception signals, a plurality of reception signal groups respectively composed of a plurality of the reception signals, and taking an average of the plurality of reception signals included in the respective reception signal groups.

10. The ultrasonic measurement apparatus according to claim 1, further comprising:
a transmission processing unit that transmits an ultrasonic wave having a predetermined wavelength toward an object from the first number of channels.

11. The ultrasonic measurement apparatus according to claim 1, further comprising:
an ultrasonic transducer device that includes the channels.

12. The ultrasonic measurement apparatus according to claim 11, further comprising:
a transmission processing unit that transmits an ultrasonic wave having a predetermined wavelength toward an object from the first number of channels among the channels included in the ultrasonic transducer device.

13. An ultrasonic imaging apparatus comprising:
a reception processing unit that performs, when information showing a normal mode or a low power consumption mode shows the normal mode, processing for receiving a first number of ultrasonic echoes from among ultrasonic echoes relating to a transmitted ultrasonic wave that are acquired from channels constituted by ultrasonic transducer elements that transmit and receive the ultrasonic wave, that performs, when the information shows the low power consumption mode, processing for receiving a second number of ultrasonic echoes that is less than the first number from among the ultrasonic echoes relating to the transmitted ultrasonic wave that are acquired from the channels, and that outputs reception signals obtained from the reception processing;
an image processing unit that receives input of the reception signals output from the reception processing unit, that adds together the first number of the reception signals with a weight that is computed in advance and performs image generation based on the reception signal obtained from the adding, when the information shows the normal mode, and that adds together the second number of the reception signals with a weight that depends on each reception signal and performs image generation based on the reception signal obtained from the adding, when the information shows the low power consumption mode; and
a display unit that displays the generated image.

14. The ultrasonic imaging apparatus according to claim 13, further comprising:
an ultrasonic transducer device that includes the channels.

15. An ultrasonic measurement method comprising:
acquiring ultrasonic echoes relating to an ultrasonic wave having a predetermined wavelength transmitted toward an object;
performing, when information showing a normal mode or a low power consumption mode shows the normal mode, processing for receiving a first number of ultrasonic echoes from among the acquired ultrasonic echoes, performing, when the information shows the low power consumption mode, processing for receiving a second number of ultrasonic echoes that is less than the first number from among the acquired ultrasonic echoes, and outputting reception signals obtained from the reception processing; and
adding together the first number of the reception signals with a weight that is computed in advance and performing image generation based on the reception signal obtained from the adding, when the information shows the normal mode, and adding together the second number of the reception signals with a weight that depends on each reception signal and performing image generation based on the reception signal obtained from the adding, when the information shows the low power consumption mode.
